(19) United States
(12) Patent Application Publication
(10) Pub. No.: US 2003/0015869 A1
(43) Pub. Date: Jan. 23, 2003

(54) Charting system

(76) Inventor: Andrew John Watson, Surrey (GB)

Correspondence Address: SHERIDAN ROSS PC, 1560 BROADWAY, SUITE 1200, DENVER, CO, 80202

(21) Appl. No.: 10/176,391

(22) Filed: Jun. 19, 2002

(30) Foreign Application Priority Data
Jun. 19, 2001 (GB) 0114958.2

(51) Int. Cl. B42D 15/00

(52) U.S. Cl. 283/115

(57) ABSTRACT

A chart is provided with a plurality of zones within which are located groups of markers, which can denominate any month of the year. A series of labels representing events, objects or times are of a shape and form to overlie all or part of a marker. The chart could be used for child development, monitoring the progress of a patient or the like. It has the advantage of being configurable and easily visible.

### FILED OF THE INVENTION

The present invention relates to a charting system for charting a series of events.

### BACKGROUND OF THE INVENTION

A problem with charting systems is that they can be difficult to configure to the needs or wishes of the user. This makes them of reduced value. Moreover, in order to provide preservability, some charting systems are in forms which actually reduce their usability.

An example is a child development book intended to record various stages in the development of a small child, typically from birth for a fixed period, such as to the age of one. These books typically have pre-printed sections to be completed by the parents. In book form they are intended to be easy to store. However, such books are substantially limited to recording the data provided for in the books and require that the format set out in the books is followed. As soon as a user omits to enter the data pertaining to a particular event set out in a book, the book becomes incomplete and its appeal is reduced. Furthermore, as such books are typically stored in a substantially hidden location (such as in a bookcase with many other books) it is easy to forget about them and thus to miss the events to be recorded. As a result of this such books are of limited use.

### SUMMARY OF THE PRESENT INVENTION

The present invention seeks to provide an improved charting system.

According to an aspect of the present invention, there is provided a charting system including a substrate and a plurality of labels attachable to the substrate, wherein the substrate is provided with a plurality of markers configurable by the user into time periods and is presentable in a substantially flat form.

Preferably, substantially the entirety of the substrate is viewable at the same time when deployed.

The markers are preferably arranged in groups, advantageously with the same number of markers in each group.

In one embodiment, the markers in each group are numbered consecutively, for example from 1 to 31. Each group may additionally include a blank marker. In this case, the labels may include time denomination labels, such as month name labels. This allows the substrate of this example to be configured in any date order such that any location can be chosen for a particular month. This allows, for example, users to chose as what they perceive to be the first group of markers to represent the month in which their child is born. For other types of charting, the first group could represent a first month at school, a first month of marriage or a first month or period of convalescence. Of course, the groups are not restricted to month denominations; the number of markers and their denominations depend upon the particular application.

Advantageously, the labels are of a shape and/or size which obstructs only a portion of a marker on the substrate. Thus, in cases where the markers are provided with symbols, such as date, day or event numbers, the labels do not obscure such symbols.

Not only is this system configurable but it allows the chart to be displayed at least substantially in its entirety for as long as it is displayed. In this manner, the development/progress can be seen regularly and the chances of missing any events is reduced. Furthermore, the subject, for example child, patient or other person, has the opportunity to view the chart regularly.

The system is preferably provided with a container in which the substrate can be housed for storage purposes. The container is advantageously provided with an identification location for identifying the substrate, hence the chart, stored therein.

### DESCRIPTION OF THE DRAWINGS

An embodiment of the present invention is described below, by way of example only, with reference to the accompanying drawings, in which:

FIG. 1 is a plan view of various embodiments of substrate of an example of child development chart system;

FIG. 2 is a plan view of an example of labels for the embodiment of FIG. 1;

FIG. 3 is a plan view showing in enlarged form some of the labels of FIG. 2; and

FIG. 4 is a perspective view of an embodiment of container for the chart of FIG. 1.

### DESCRIPTION OF THE PREFERRED EMBODIMENT

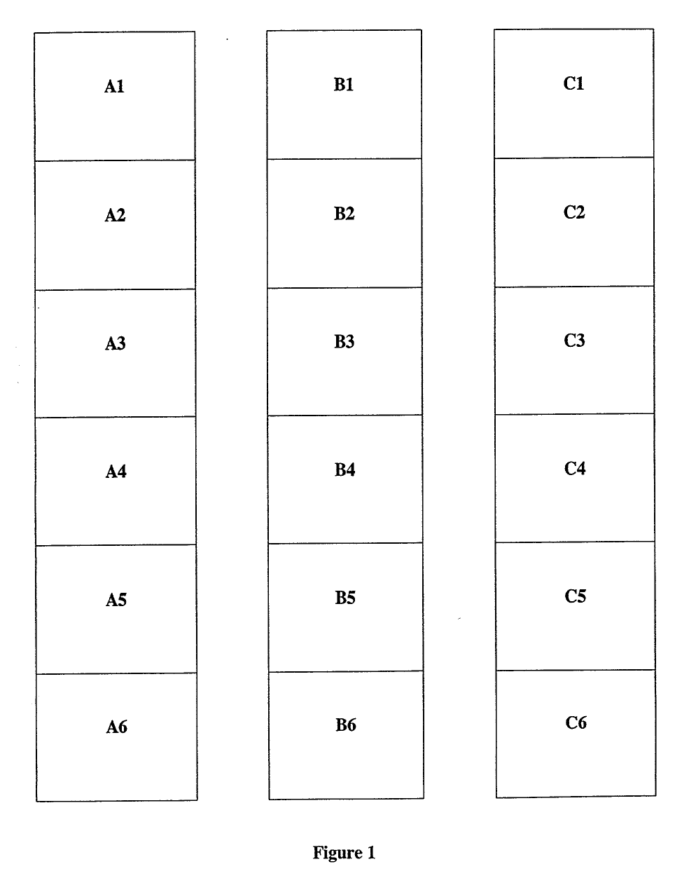

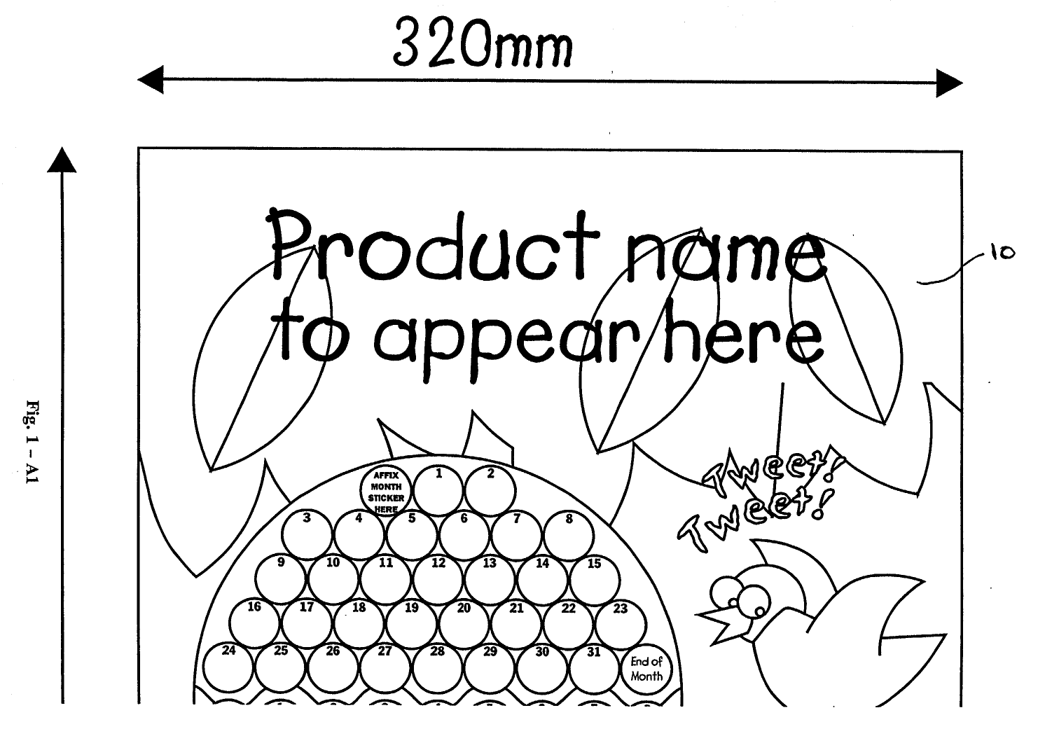

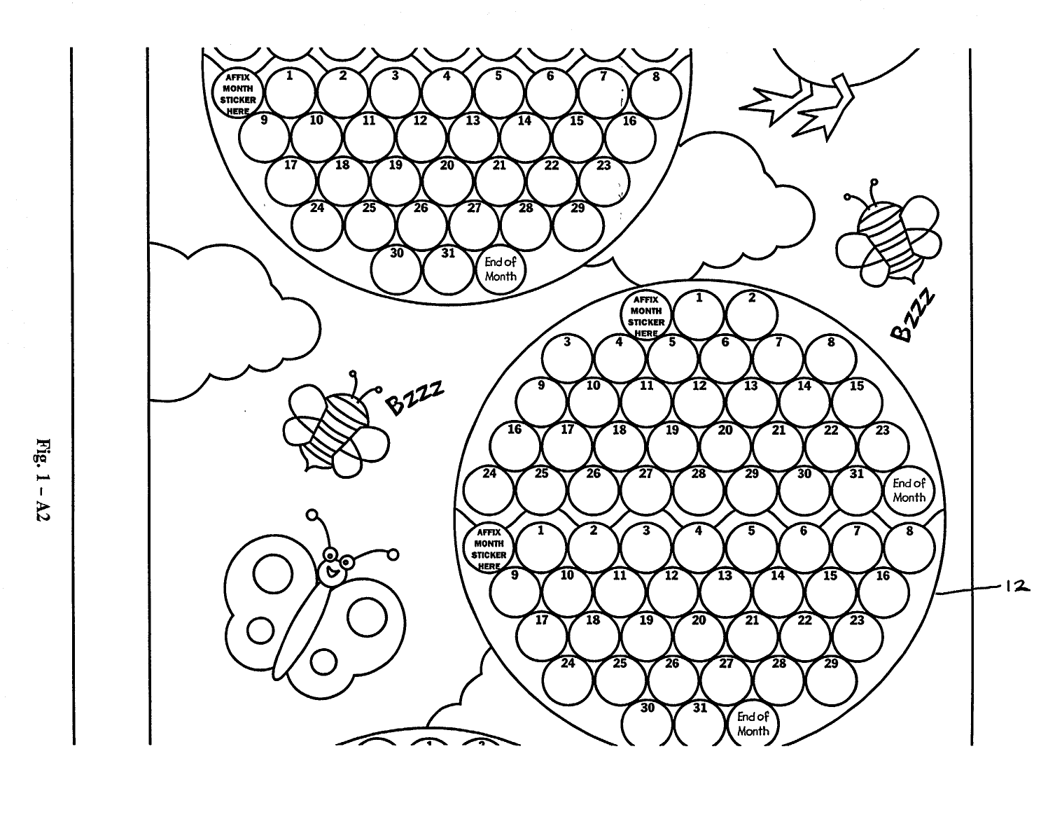

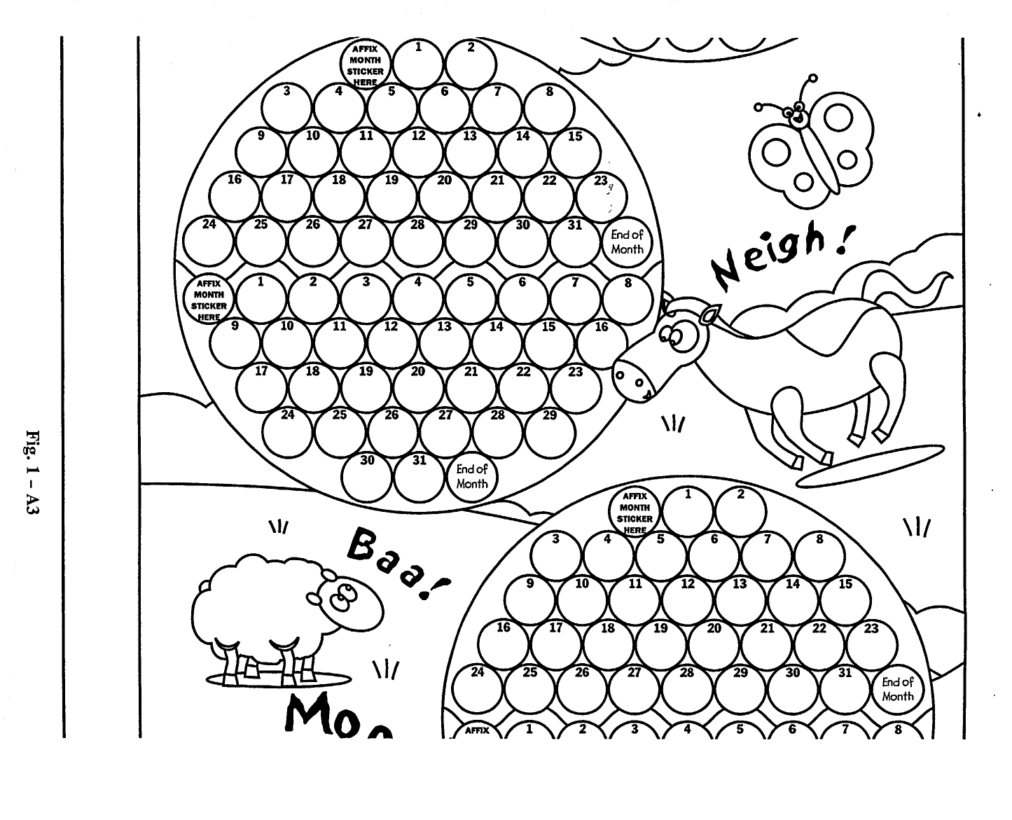

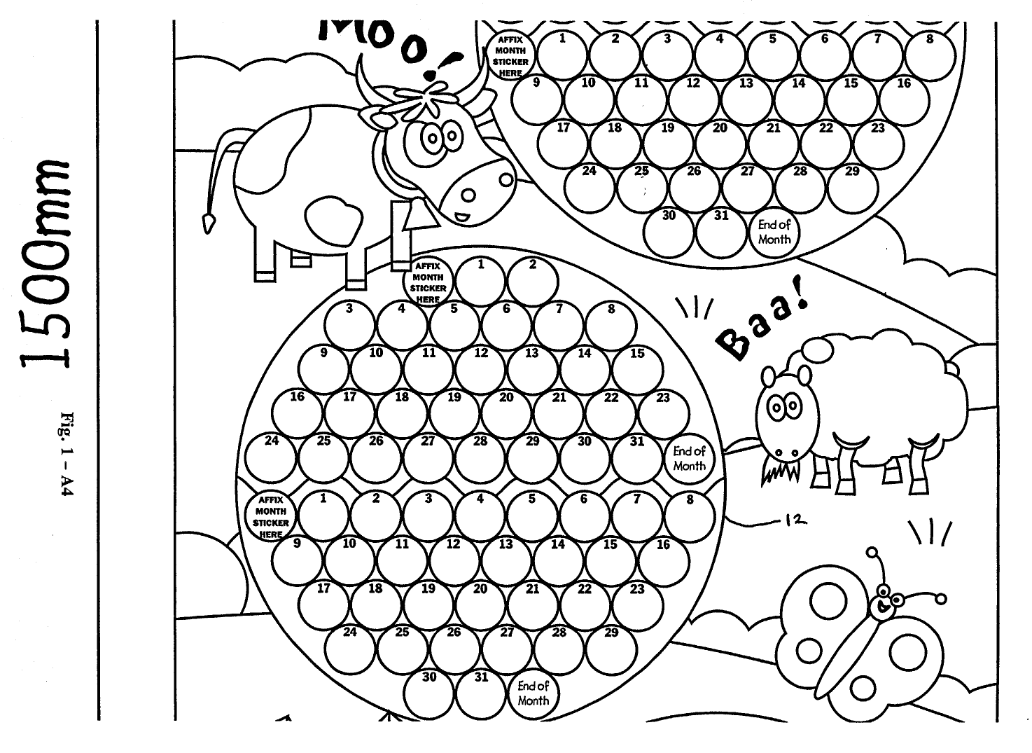

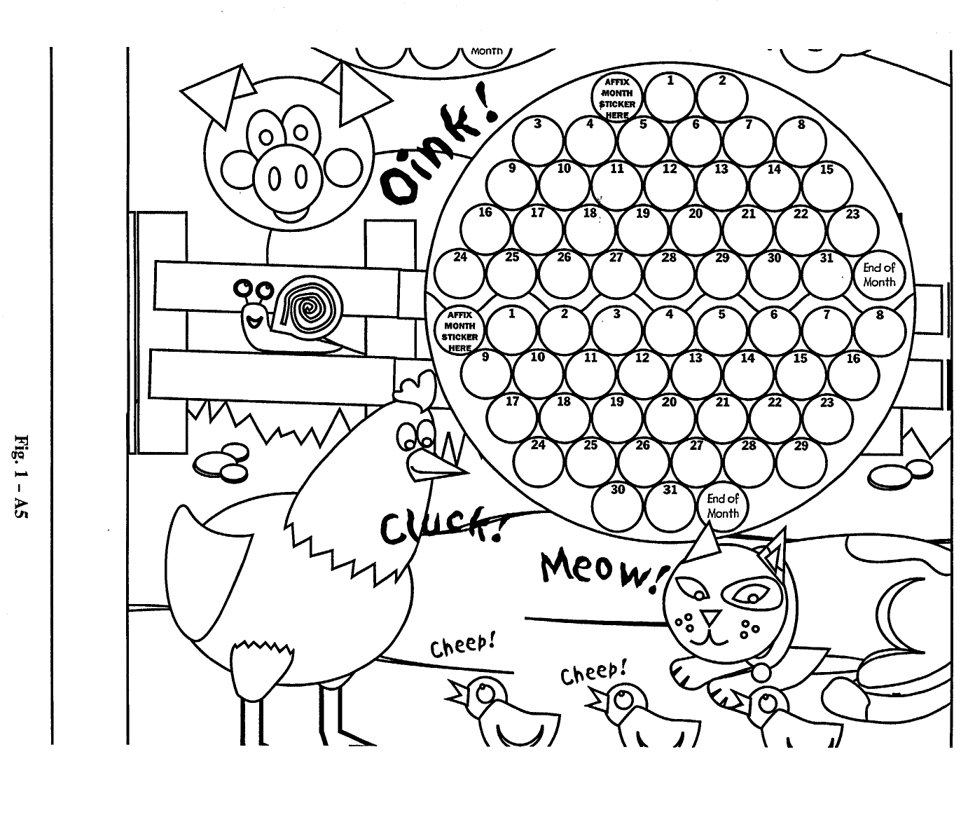

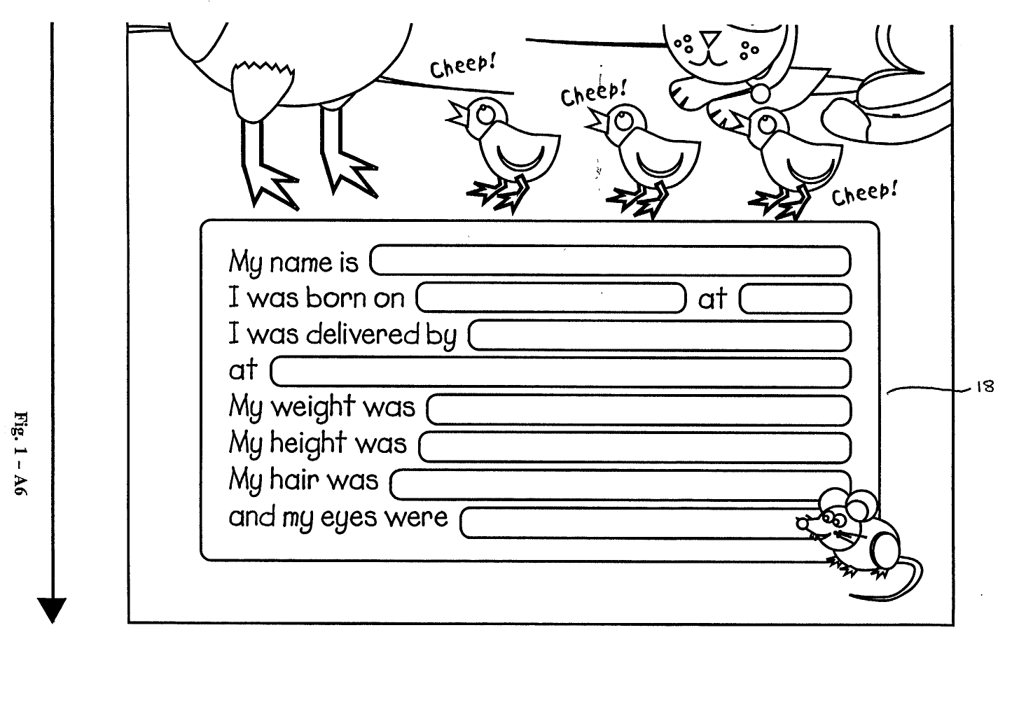

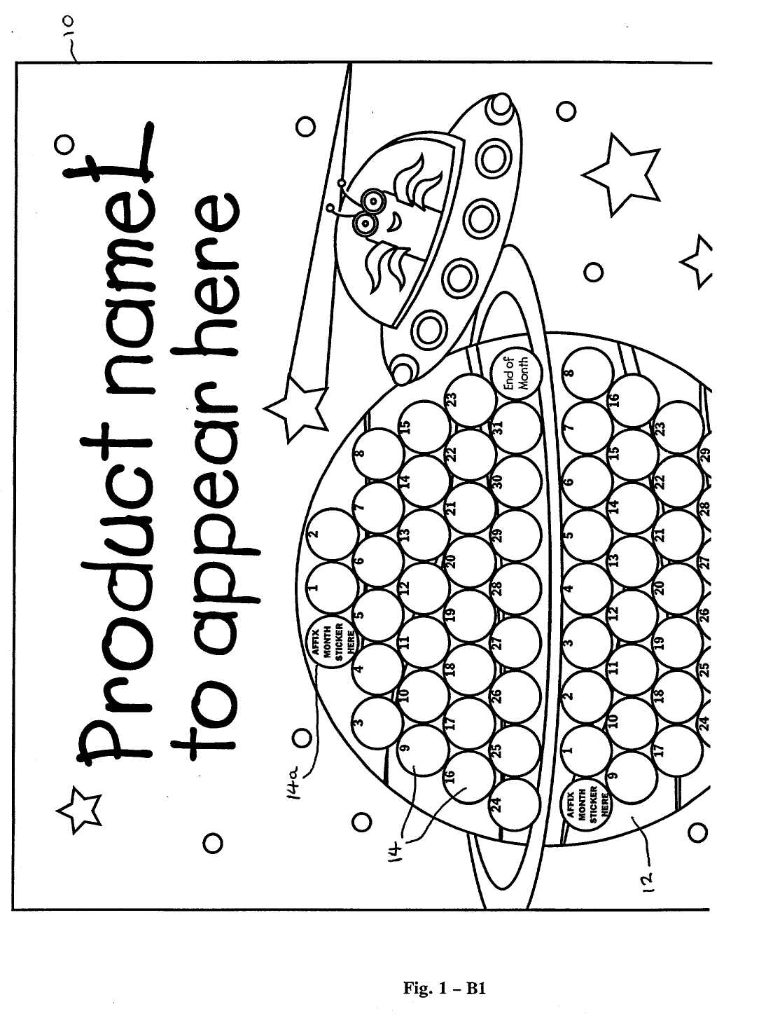

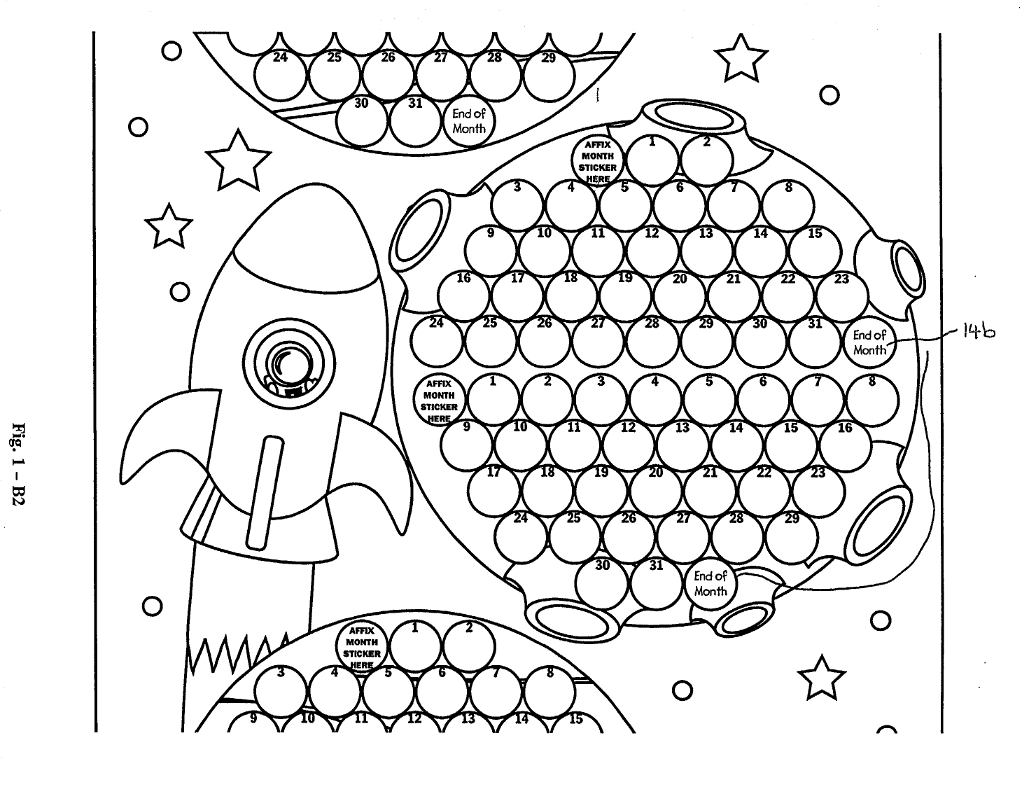

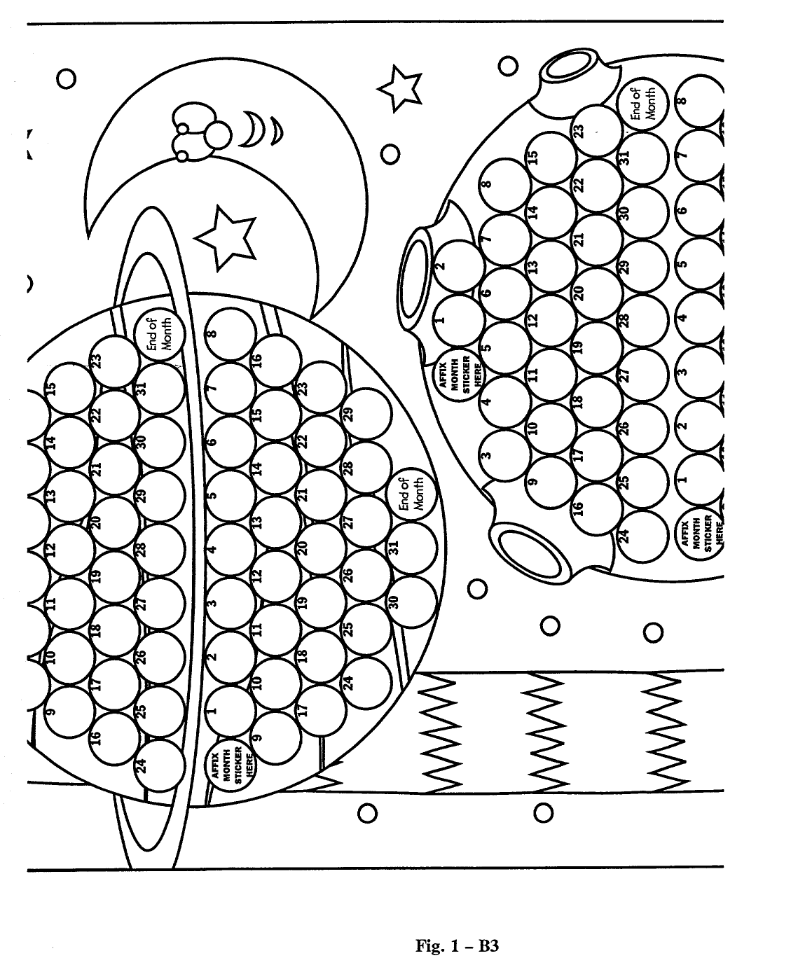

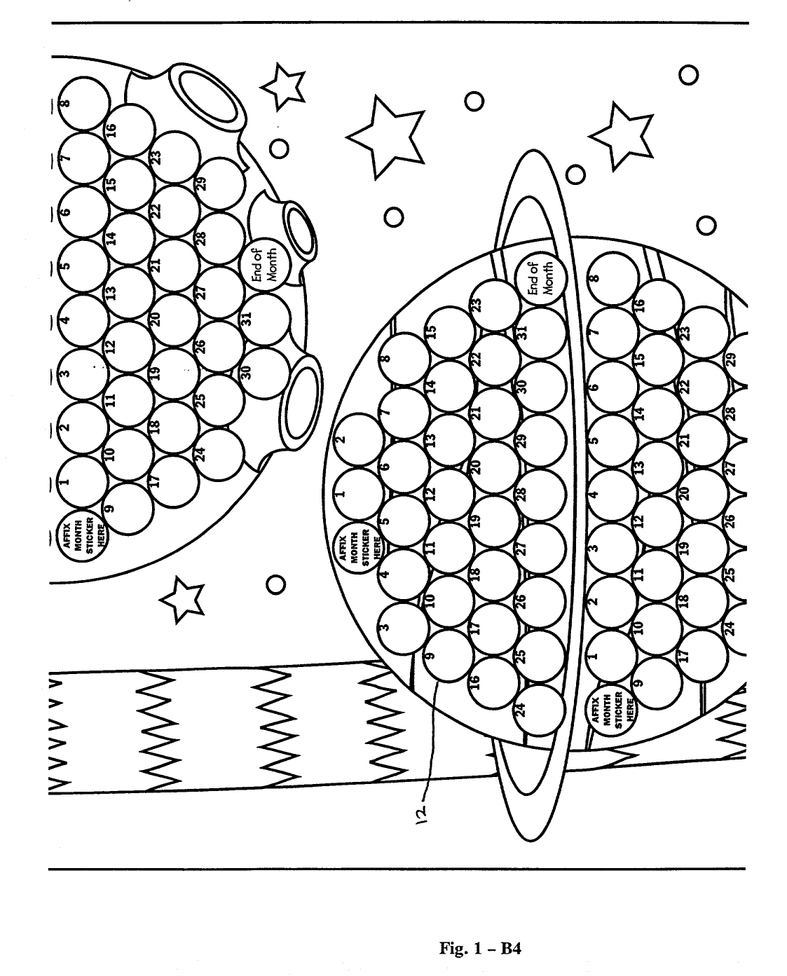

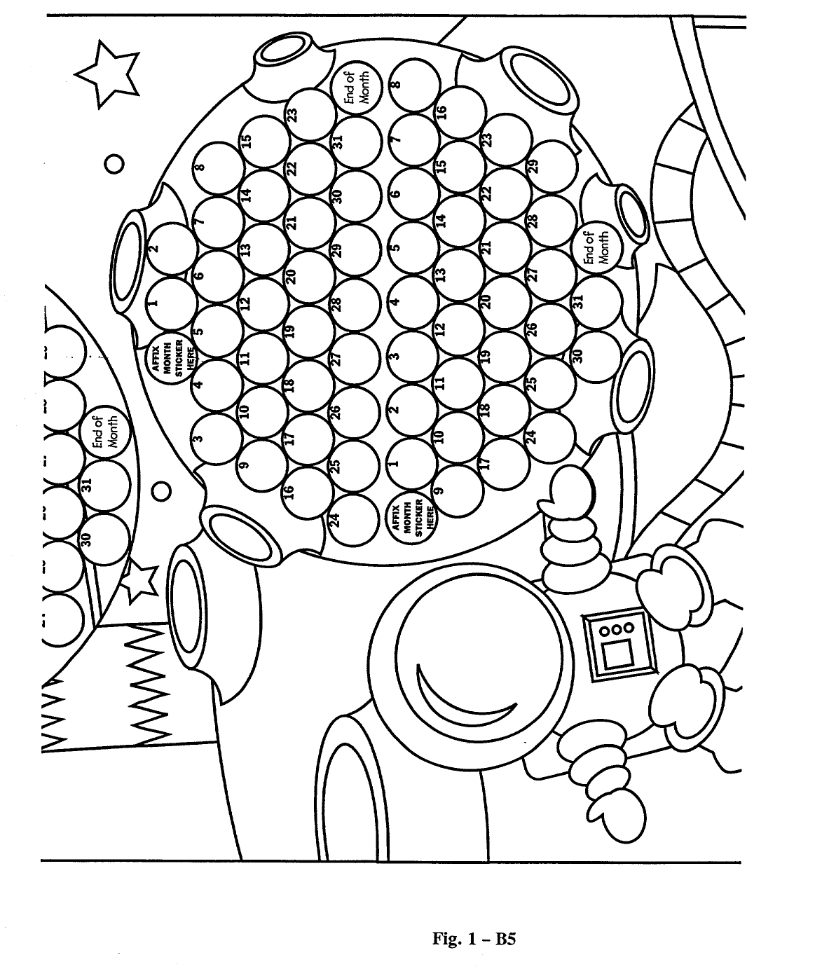

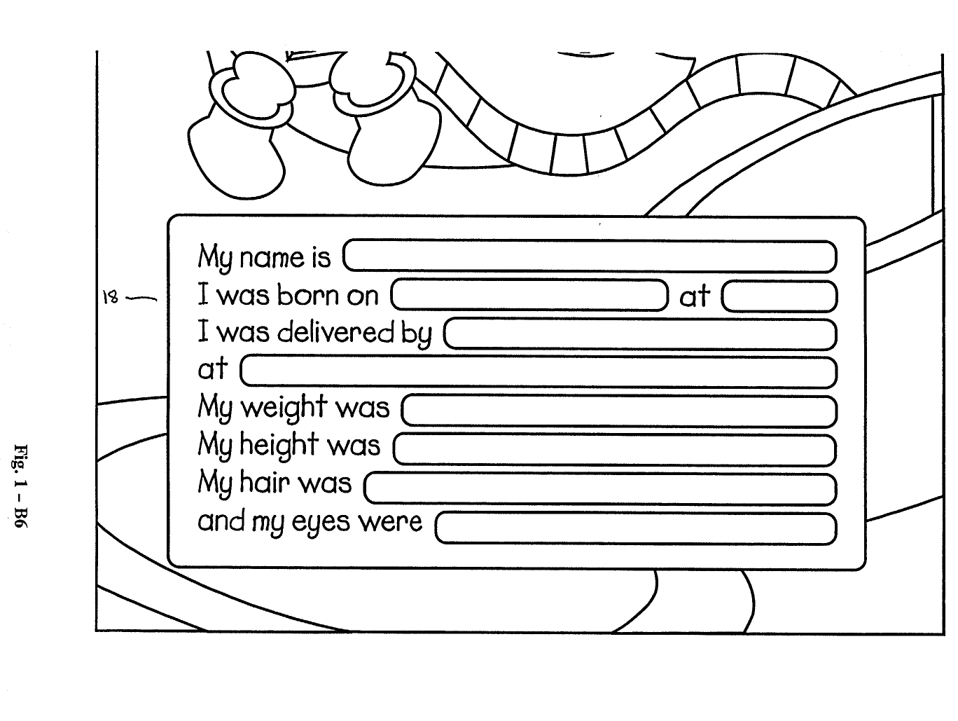

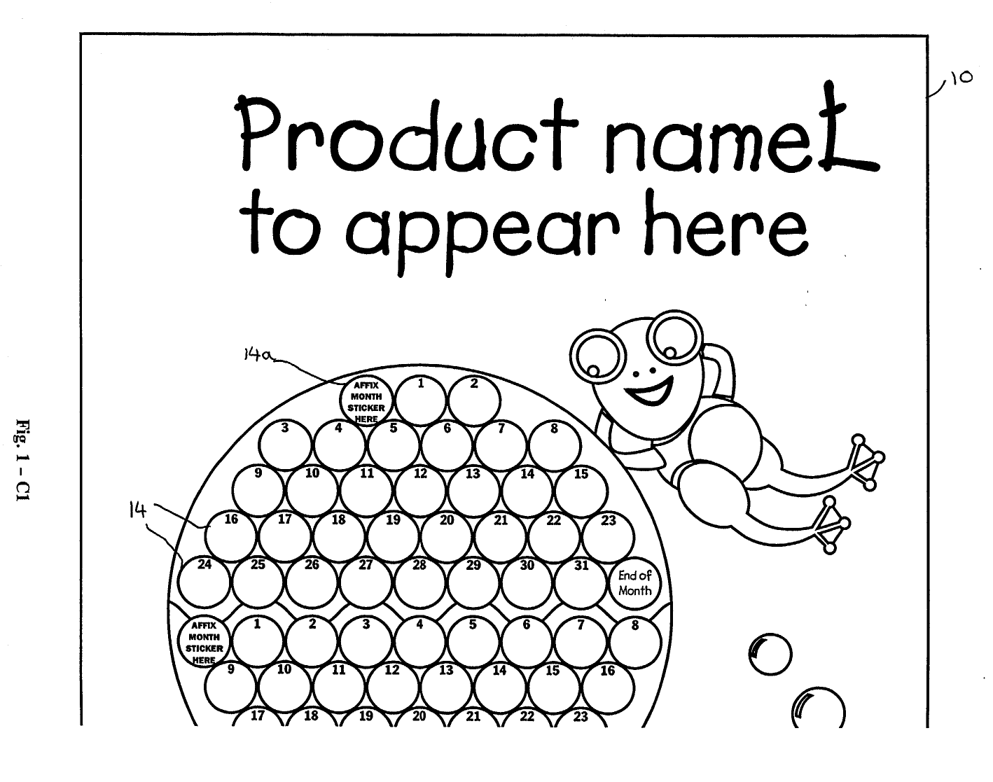

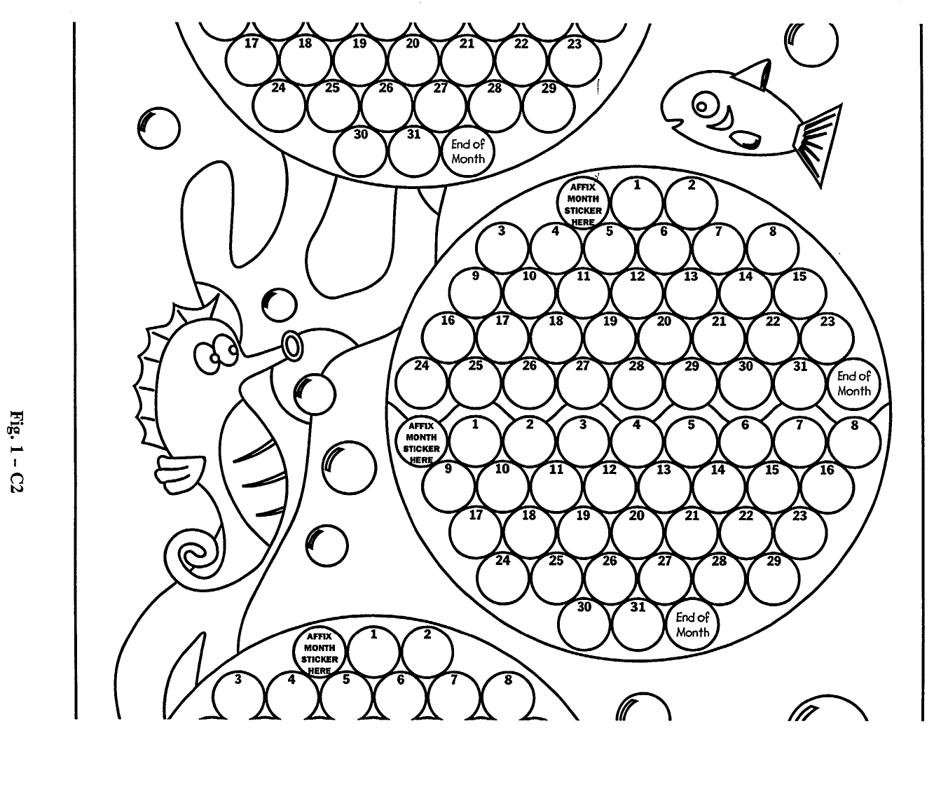

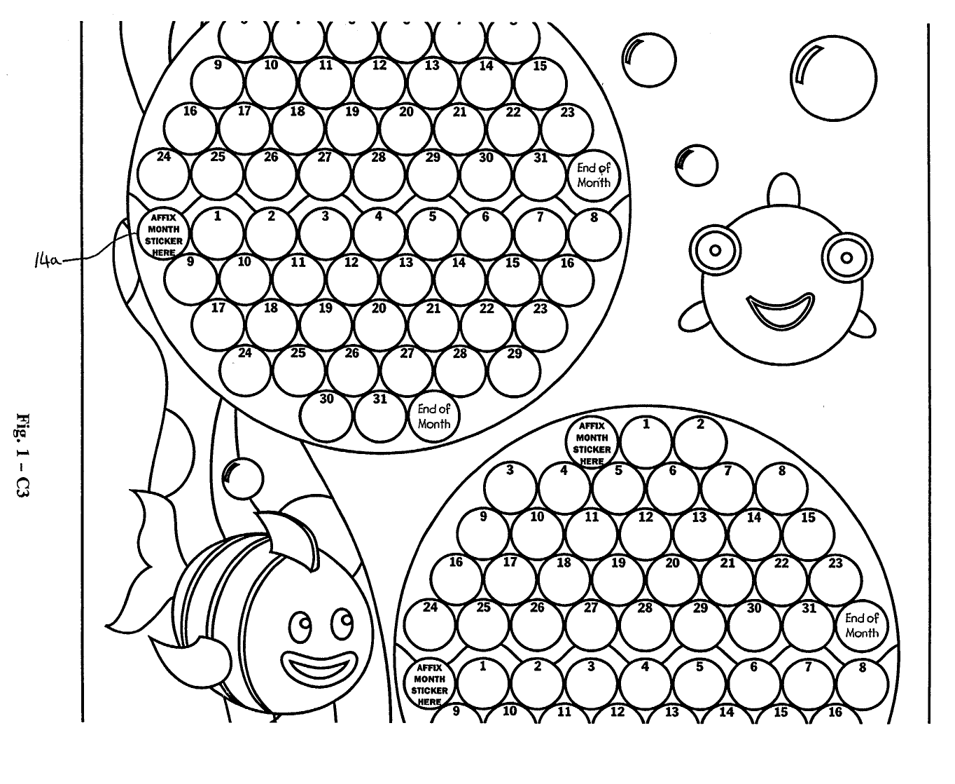

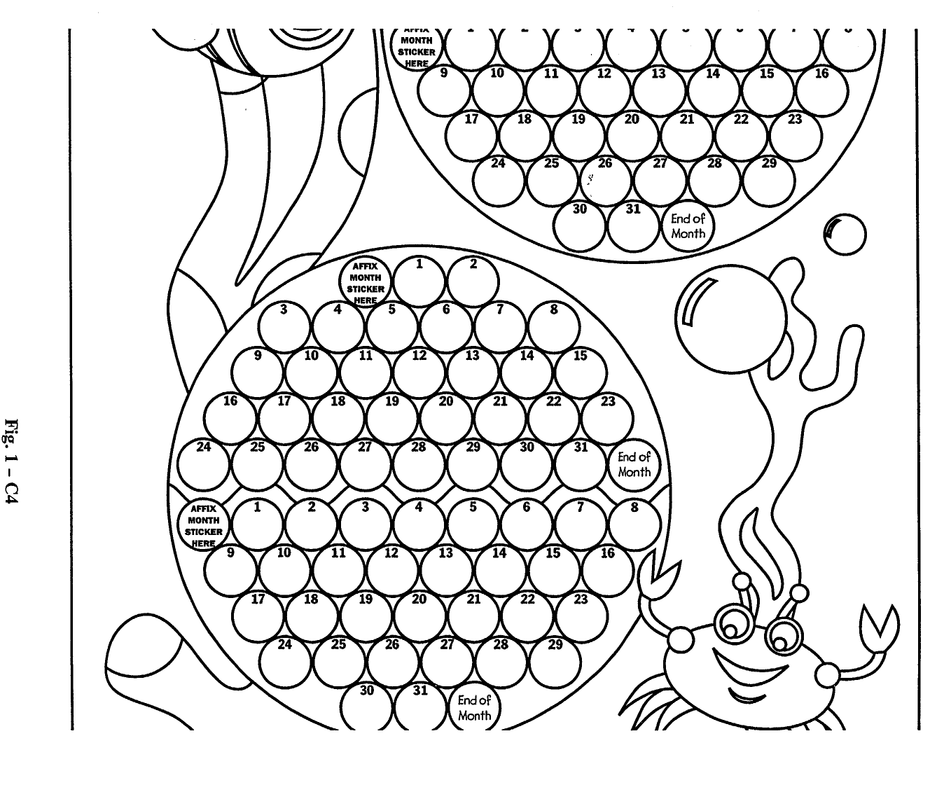

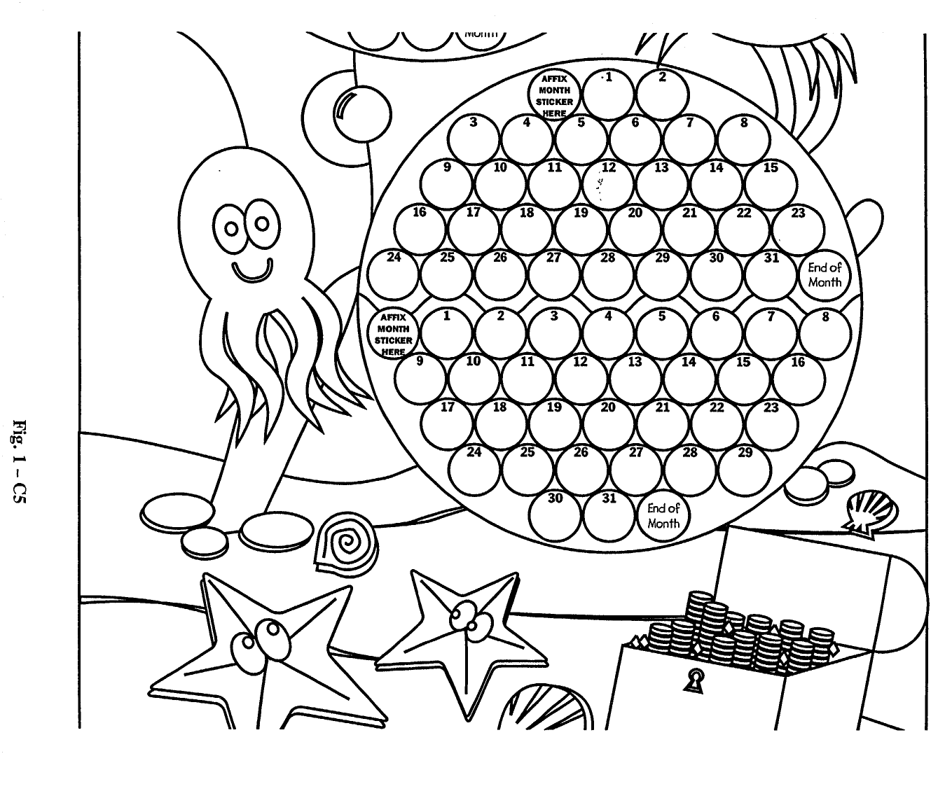

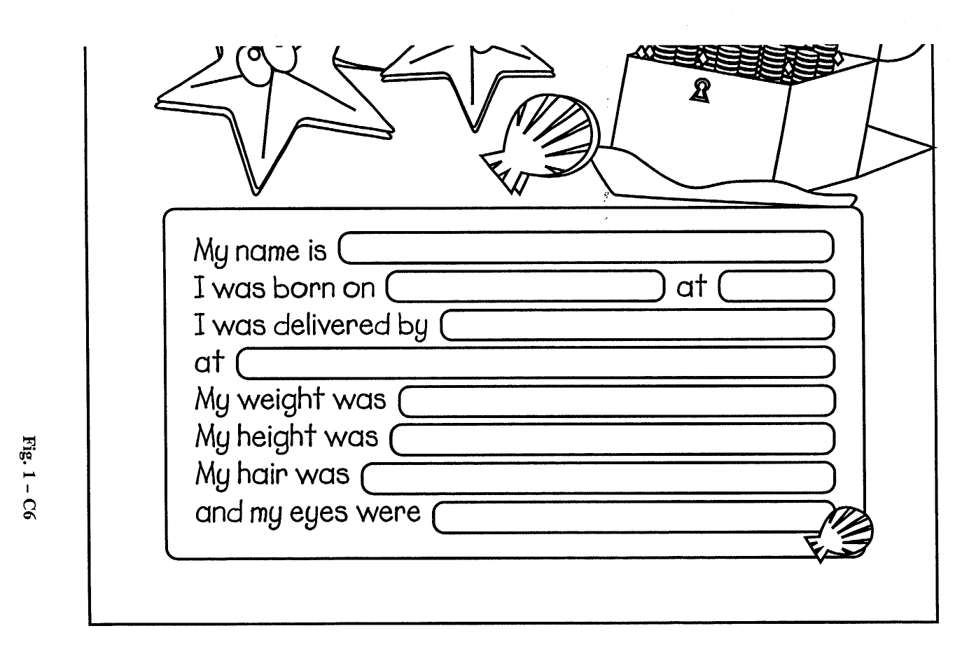

Referring to FIG. 1, there is shown a substrate 10 which in this example can be used to produce a child development chart. The substrate 10 is provided with a plurality of zones 12 within which are located groups of markers. In the example shown, there are six zones 12 and are arranged to provide a chart extending over a one year period. The number of zones, their contents and their arrangements can be chosen as desired on the basis of the particular application for which the system is to be used.

The overall shape of the substrate 10 and its material can be chosen as desired. In this example, the substrate 10 is formed of a printable medium such as paper or card and is in a form which can be rolled for storage purposes, as described below. The substrate 10 may be laminated to add durability. A particular form of the substrate 10 allows the substrate 10 to be hung on a wall or on a door.

In this example, each zone 12 is provided with a plurality of markers 14. There are provided in the embodiment shown sufficient markers 14 in each zone 12 for each day of two months, preferably two sets of thirty-one markers 14 in which in each set of the markers are numbered from 1 to 31 consecutively. Each set also comprises a marker 14a intended to designate the particular month which that group of markers 14 is to represent. There may also be provided in each set of markers 14 a marker 14b indicating the end of that period, in this example the end of the month. In the arrangement shown in FIG. 1, the six zones 12 provide enough markers 14 to chart an entire year.

The numbers of markers 14 in each zone 12 are the same in the preferred embodiment, such that each group of markers 14 can denominate any month of the year. Therefore, it is not necessary for the top group of markers 14 to represent January but can represent any month of the year. When the chart is intended to log the development of a baby from birth, the top group of markers 14 can be made to represent the month in which the child is born. This feature is relevant not only in a case of child development but for any series of events which may not necessarily start at a fixed point in time. Another example could be in charting the convalescence of a patient over a period of days, weeks or months when a first group of zones represent the start of a period of convalescence. The chart could be also be used to monitor the taking of medicaments, particularly in cases where a person is required to take medicaments regularly and for which it is important not to forget any dose.

The substrate 10 shown in FIG. 1 in this particular example is also provided with a height chart (not shown) and with a naming area 18 in which the details of a particular child can be entered. In another example, such as for convalescence, the name of the patient, the nature of the operation or treatment and details of the convalescent period and convalescent treatment required can be written down in appropriate boxes, each of which is denominated with a relevant title (patient's name, etc.). In the case of a medicament chart, the details of the medicament taken and intervals of time at which medicament are to be taken can be provided for in this area 18.

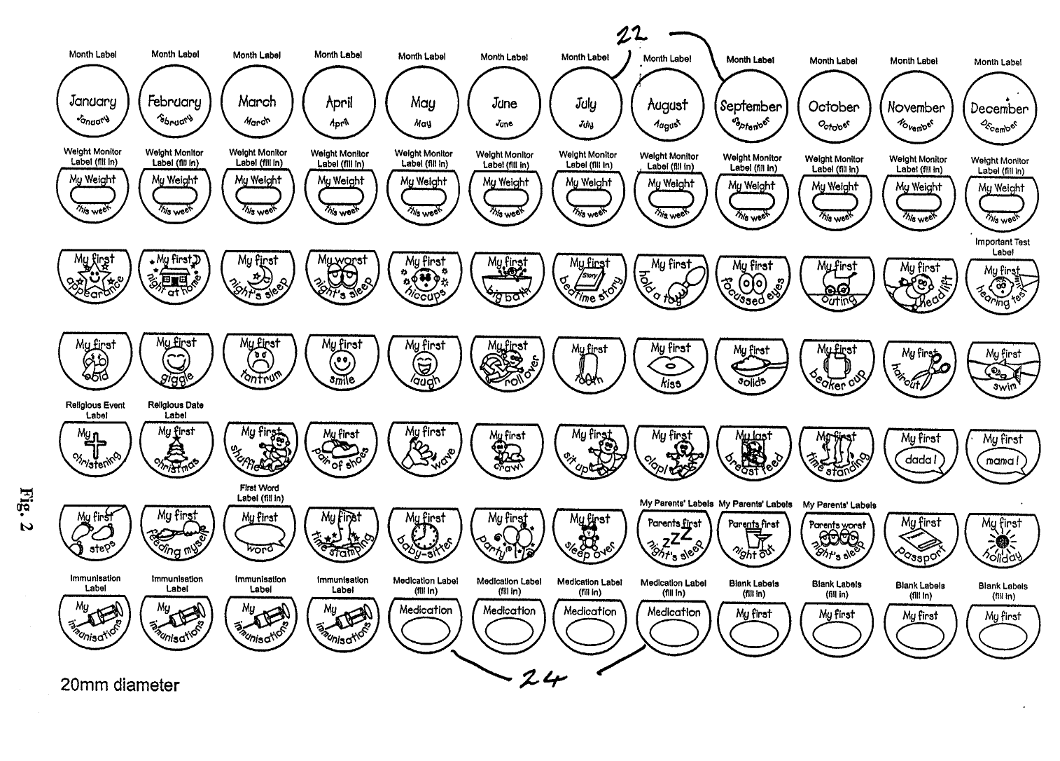

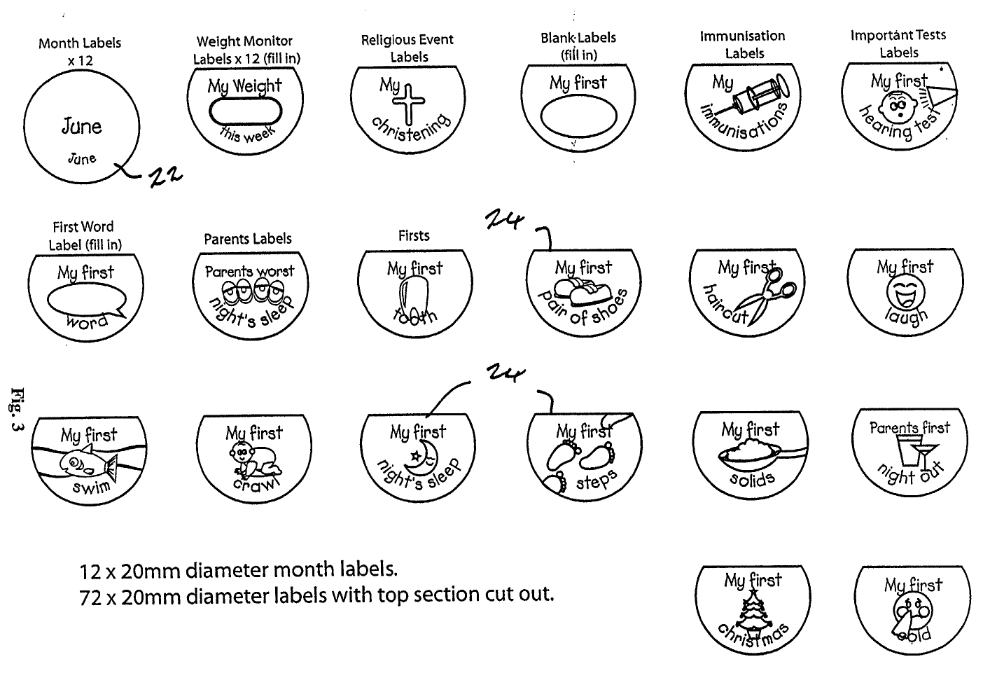

Referring now to FIGS. 2 and 3, there is shown an example of labels to be used on the substrate 10 and in particular to be placed on the markers 14. It can be seen that there are two types of labels shown in FIG. 2, the first type label 22 is of a shape and form which would cover the entirety of one of the markers 14. In this case, the labels 22 represent the month of the year and are intended to be placed over the markers 14a. The second set of labels 24 are of a shape by which they do not cover the entirety of the markers 14. In this case, the labels 24 could be said to have had their top portion cut off. With reference to FIG. 1, it can be seen that the label 24 would not obscure the numerals of the markers 14 such that when placed on the markers 14 it is still possible for the user to determine the day upon which that particular event took place.

In the example shown in FIG. 2, the labels 24 include some labels representative of particular events in the development of a baby, such as personal growing events of the baby and events to which the baby is subjected, such as immunisations, illnesses providing later immunity.

Furthermore, there are also included labels which can be annotated by the user to detail events which are not provided for in pre-printed form on the labels 24.

In use, at the time of birth of the child, the parents can set up the charting system such that the top group of markers 14 is made the month in which the child is born (in other words the appropriate month label 22 is placed in the top marker 14a if this is the parent's choice to start at this location on the chart) with the label 24 representing the birth being placed on the appropriate day marker 14. Thereafter, when a particular development stage is reached, the appropriate label 24 is placed on the marker 14 representing the date on which that event took place. Where there is no suitable label, either an annotatable label 24 is used or the substrate 10, at the appropriate marker 14, is written on. No event need therefore be missed in the chart.

In the preferred embodiment, the labels 22, 24 and the substrate 10 are formed such that the labels can be removed from the substrate and placed in new positions on the substrate 10.

As the chart is always visible, it gives a very clear picture of the development of that child over time and can be reviewed regularly so as to ensure that the users (parents in this example) do not forget about the chart and the need to complete it.

The area 18 would be completed to personalise the chart to the particular child.

In the example where the system is used to chart the convalescence of a patient, there maybe provided labels representative of particular convalescence events (for example particular improvements in the condition of a patient). In the case where the system is to be used to monitor the taking of medicaments, the label may represent the type of medicament and the area 18 may indicate the frequency at which that medicament is to be taken.

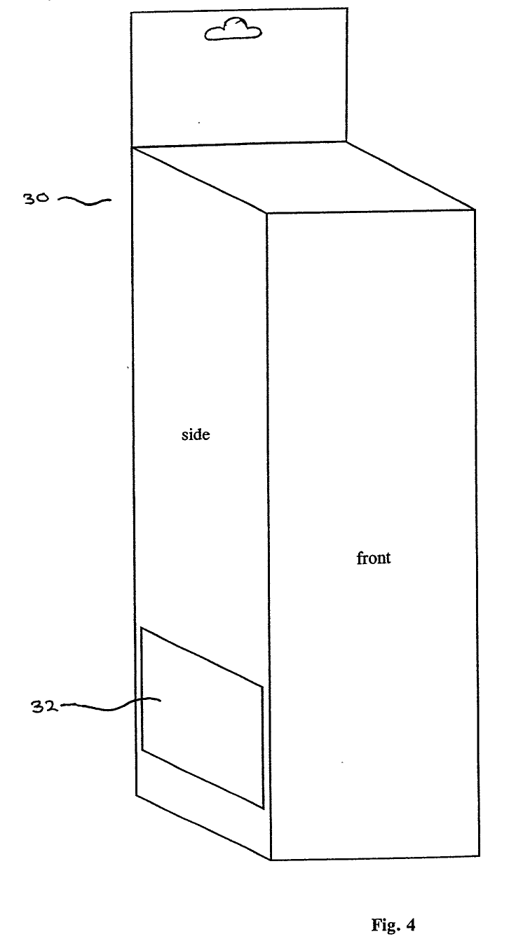

The system is provided with a container 30 as shown in FIG. 4, which may for example be made of cardboard, for storage purposes. The container is advantageously provided with an identification system 32 similar to that shown in area 18 of the substrate 10 which can be used to identify the subject of the chart stored therein. This may be relevant, in the examples given, when there may be a plurality of children in a family or when there may be a plurality of different charts charting different stages in the development of a child. In the case of a system used to monitor the convalescence of a patient or the taking of medicaments, such a container can be particularly useful for later reference.

It will be apparent to the skilled person that many variations and modifications can be made to the above-described embodiments which are intended to fall within the scope of the claims.

I claim:

1. A charting system comprising a substrate and a plurality of labels attachable to the substrate, wherein the substrate is provided with a plurality of markers configurable by the user into time periods and is presentable in a flat form.

2. A system according to claim 1, wherein the entirety of the substrate is viewable at the same time when deployed.

3. A system according to claim 1, wherein the markers are arranged in groups.

4. A system according to claim 3, wherein the same number of markers is provided in each group.

5. A system according to claim 3, wherein the markers in each group are numbered consecutively.

6. A system according to claim 1, wherein the labels include time denomination labels.

7. A system according to claim 1, wherein the labels are of a shape and size which obstructs only a portion of a marker on the substrate.

8. A system according to claim 1, further comprising a container in which the substrate can be housed.

9. A system according to claim 8, wherein the container is provided with an identification location for identifying a substrate to be stored therein.

10. A charting system according to any preceding claim designed to monitor a patient.

11. A charting system according to any preceding claim designed to monitor development of a child.
